(19) United States
(12) Patent Application Publication
(10) Pub. No.: US 2024/0298348 A1
(43) Pub. Date: Sep. 5, 2024

(54) METHOD OF RESOURCE ALLOCATION FOR PRACH TRANSMISSION

(71) Applicant: ZTE Corporation, Shenzhen (CN)

(72) Inventors: Junfeng Zhang, Shenzhen (CN); Xing Liu, Shenzhen (CN); Xianghui Han, Shenzhen (CN); Jing Shi, Shenzhen (CN); Xingguang Wei, Shenzhen (CN)

(73) Assignee: ZTE Corporation, Shenzhen (CN)

(21) Appl. No.: 18/661,236

(22) Filed: May 10, 2024

Related U.S. Application Data
(63) Continuation of application No. PCT/CN2022/111558, filed on Aug. 10, 2022.

(51) Int. Cl. H04W 74/00; H04W 74/0833

(52) U.S. Cl. CPC H04W 74/004; H04W 74/0833

(57) ABSTRACT

Methods, devices, and non-transitory computer readable media are provided for configuring physical random access channel (PRACH) retransmissions in a wireless communication network. A PRACH trigger is received including a random access channel occasion (RO) indication. A PRACH preamble is transmitted to a base station during a first RO specified by the RO indication. One or more PRACH preamble repetitions are transmitted to the base station during a second RO specified by the RO indication. A random access response (RAR) is received from the base station in response to the PRACH preamble and/or the one or more PRACH preamble repetitions.

### CROSS-REFERENCE TO RELATED APPLICATIONS

This application is a continuation of co-pending International Patent Application No. PCT/CN2022/111558, filed Aug. 10, 2022. The contents of International Patent Application No. PCT/CN2022/111558 are herein incorporated by reference in their entirety.

### TECHNICAL FIELD

The present subject matter is directed generally to wireless communications. Particularly, the present subject matter relates to methods, devices, and systems for enhancing cell coverage during an initial access procedure in a wireless communication network.

### BACKGROUND

As present resource allocation techniques in wireless communication systems suffer from a variety of drawbacks, limitations, and disadvantages, there is a need for inventive systems, methods, components, and apparatuses described herein.

### SUMMARY

The present subject matter is directed to a method, device, and system for improving measurement techniques in wireless communication. Specifically, the present subject matter relates to resource allocation for PRACH repetitions in a New Radio (NR) communication network.

In some embodiments, a method is provided for configuring physical random access channel (PRACH) retransmissions in a wireless communication network by a user equipment (UE), comprising: receiving a PRACH trigger comprising a random access channel occasion (RO) indication; transmitting a PRACH preamble to a base station during a first RO specified by the RO indication; transmitting one or more PRACH preamble repetitions to the base station during a second RO specified by the RO indication; and receiving a random access response (RAR) from the base station in response to the PRACH preamble and/or the one or more PRACH preamble repetitions.

In some embodiments, a method is provided for configuring PRACH retransmissions in a wireless communication network by a base station, comprising: transmitting a PRACH trigger comprising an RO indication to a UE, wherein the PRACH trigger is one of: System Information (SI), a physical downlink control channel (PDCCH) order, ra-ssb-OccasionMaskIndex, or BeamFailureRecovery; receiving a PRACH preamble from the UE during a first RO specified by the RO indication; receiving one or more PRACH preamble repetitions from the UE during a second RO specified by the RO indication; and transmitting a RAR to the UE in response to the PRACH preamble and/or the one or more PRACH preamble repetitions.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless base stations and one or more user equipment.

FIG. 2 shows an example of a base station.

FIG. 3 shows an example of a user equipment.

FIG. 4 shows an example communication of PRACH repetitions across the association period.

FIG. 5 shows an example PRACH repetition communication.

### DETAILED DESCRIPTION

The present subject matter will now be described in detail hereinafter with reference to the accompanied drawings, which form a part of the present subject matter, and which show, by way of illustration, specific examples of embodiments. Please note that the present subject matter may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

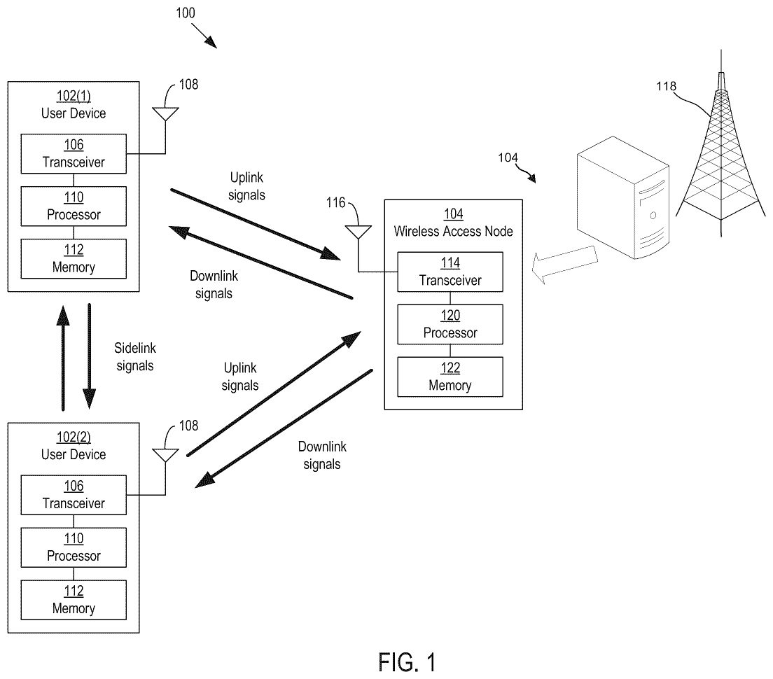

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition, or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals may be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in the wireless communication system 100, a slot format for a plurality of slots (occasions) or frames may be configured by the wireless access node 104 or specified by a protocol. In some examples, a slot may be indicated or specified as a downlink slot, a flexible slot, or an uplink slot. Also, an orthogonal frequency divisional multiplexing (OFDM) symbol may be indicated or specified as a downlink symbol, a flexible symbol, or an uplink symbol, in various embodiments.

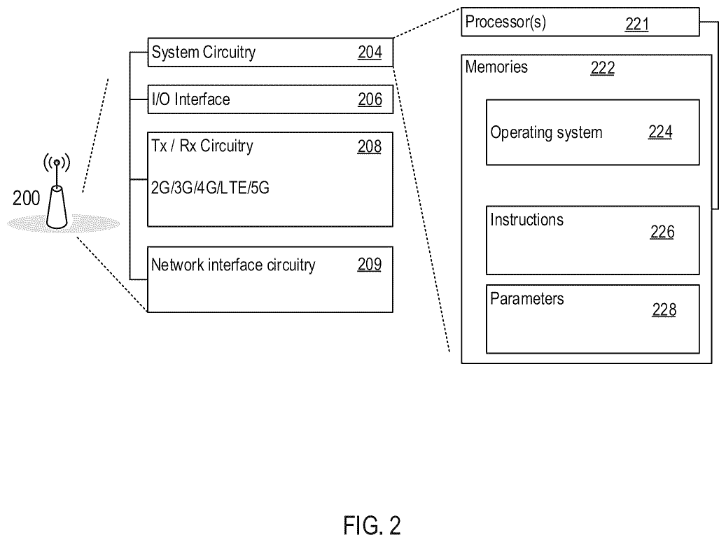

FIG. 2 shows an example of base station 200. The example base station 200 may include radio transmitting/receiving (Tx/Rx) circuitry 208 to transmit/receive communication with UEs and/or other base stations. The base station 200 may also include network interface circuitry 209 to communicate the base station 200 with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station 200. The parameters 228 may include parameters to support execution of the instructions 226. For example, parameters may include network protocol settings, bandwidth parameters, radio frequency mapping assignments, and/or other parameters.

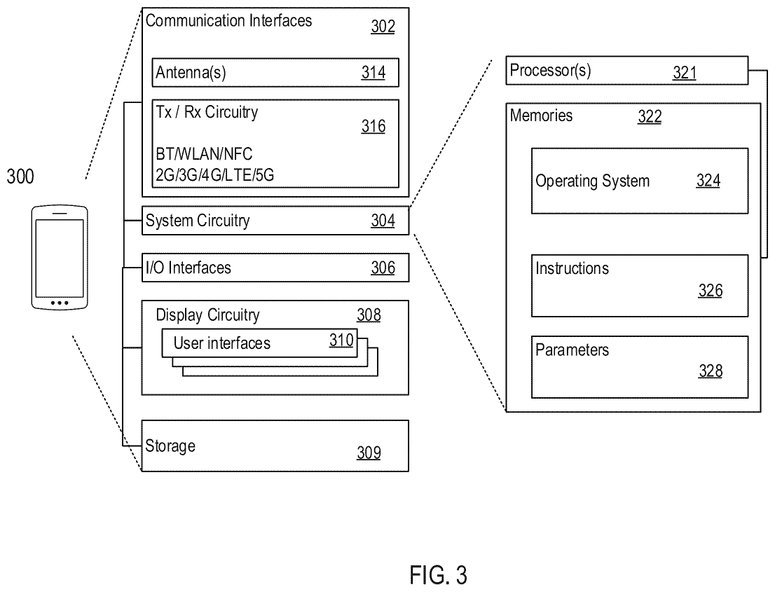

FIG. 3 shows an example of a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present subject matter describes several example embodiments, which may be implemented, partly or totally, on the base station 200 and/or the UE 300 described with reference to FIGS. 1-5.

The conventional NR system has introduced a basic scheme to support initial access under FR1 (<6 GHz band) and FR2 (>6 GHz band). The scheme includes different physical random access channel (PRACH) formats and PRACH resource configurations, as well as defines the relationship between the synchronization signal block (SSB) and PRACH, the mechanism of PRACH retransmissions, the mechanism of PRACH power control, and the like.

The RACH occasion (RO) is the time and frequency domain resource for PRACH transmission. A predefined association exists between the SSB and RO, but the association in the basic PRACH procedure does not optimize the PRACH repetition. Thus, the ROs for PRACH repetition will disperse to different associations periods and the latency of the RACH procedure is too long to be accepted.

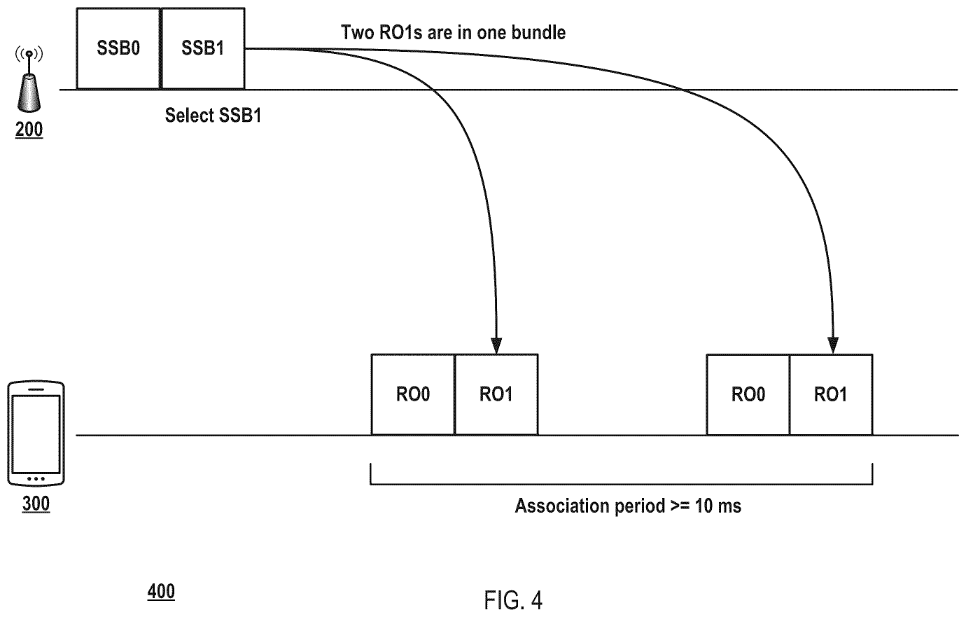

Now referring to FIG. 4, an example communication 400 of PRACH repetitions across the association period are shown between a base station 200 and a UE 300 where SSB1 is selected and two RO1s form one bundle. The typical association period is 10 ms or longer, which means the transmission of the whole bundle of PRACH repetitions having a repetition factor of 2 should be at last 20 ms to be completed.

### Resource Indication for PRACH Repetition Using a PRACH Mask Index

A PRACH mask index may be used to indicate the PRACH occasion(s) for PRACH transmission under the following cases.

(1) PRACH transmission may be triggered by a PDCCH order from the base station 200. A certain value in the PRACH mask index field in PDCCH order may indicate the PRACH occasion for the PRACH transmission, where the PRACH occasions may be associated with the SS/PBCH block index indicated by the SS/PBCH block index field of the PDCCH order. The certain value may be from the PRACH mask index table.

(2) PRACH transmission may be triggered by higher layers, and the contention free random access procedure based on SSB measurement may be applied. When the radio resource control (RRC) parameter ssb-ResourceList is provided, the PRACH mask index may be indicated by the RRC parameter ra-ssb-OccasionMaskIndex which may indicate the PRACH occasions for the PRACH transmission, where the PRACH occasions may be associated with the selected SS/PBCH block index. The value of parameter ra-ssb-OccasionMaskIndex may also form the PRACH mask index table.

(3) PRACH transmission may be triggered by BeamFailureRecovery and the contention free random access procedure based on SSB measurement may be applied. Note, the PRACH transmission triggered by BeamFailureRecovery may fall back to contention-based RACH procedure, this case is not within the scope of the present subject matter.

(4) PRACH transmission may be triggered for the System Information (SI) request. Although the preamble index may be uniquely identified based on SSB measurement and association between the SSB and RO, PRACH triggered by the SI request may not be the contention-free random access procedure, but rather, the contention-based random access procedure as other UE(s) may use the same preamble index unrestricted.

PDCCH order via DCI is a UE-specific signaling, and the PRACH mask index within PDCCH order may be individually indicated to each UE 300 according to the UE-specific number of PRACH repetition(s), i.e., the value of the PRACH mask index for each UE may be different. PDCCH order signaling provides much flexibility to PRACH occasion resource allocation for PRACH repetition.

When PRACH transmission is triggered by higher layers, the contention-free random access procedure based on SSB measurement may be applied. The RRC parameter ra-ssb-OccasionMaskIndex, which indicates the PRACH occasions for the PRACH transmission, may be the UE-specific RRC parameter, which also provides much flexibility to PRACH occasion resource allocation for PRACH repetition.

Similarly, when PRACH transmission is triggered by beam failure recovery and the contention-free random access procedure based on SSB measurement is applied, the RRC parameter ra-ssb-OccasionMaskIndex, which indicates the PRACH occasions for the PRACH transmission, may be the UE-specific RRC parameter too.

When PRACH transmission is triggered by the SI request, the RRC parameter ra-ssb-OccasionMaskIndex, which indicates the PRACH occasions for the PRACH transmission, may be a common RRC parameter carried in system information. The RRC parameter ra-ssb-OccasionMaskIndex may be used differently compared with above other cases, as this parameter may be regarded as a common parameter which belongs to the UEs 300 in group for the same SI request intention.

The conventional PRACH mask index table in current 3GPP specification 38.321 is provided in Table 1 below:

TABLE 1
Conventional PRACH Mask Index values

| PRACH Mask | |
|---|---|
| Index | Allowed PRACH occasion(s) of SSB |
| 0 | All |
| 1 | PRACH occasion index 1 |
| 2 | PRACH occasion index 2 |
| 3 | PRACH occasion index 3 |
| 4 | PRACH occasion index 4 |
| 5 | PRACH occasion index 5 |
| 6 | PRACH occasion index 6 |
| 7 | PRACH occasion index 7 |
| 8 | PRACH occasion index 8 |
| 9 | Every even PRACH occasion |
| 10 | Every odd PRACH occasion |
| 11 | Reserved |
| 12 | Reserved |
| 13 | Reserved |
| 14 | Reserved |
| 15 | Reserved |

Mask Index 0 in Table 1 means all the allowed PRACH occasion(s) of the SSB can be randomly selected by the UE 300 for PRACH transmission. It may be especially meaningful when the parameter ssb-perRACH-Occasion in combination with the parameter ssb-perRACH-OccasionAndCB-PreamblesPerSSB is smaller than 1 and many RACH occasions may be candidates. For example, if the ssb-perRACH-Occasion in combination with the parameter ssb-perRACH-OccasionAndCB-PreamblesPerSSB is 1/8, and then 8 of RACH occasions may be candidates for RACH transmission. The 8 RACH occasions may be regarded as a RACH bundle.

From Mask Index 11 to 15 in Table 1, the indexes are reserved for future use. The reserved indexes may be used for indicating the RACH occasions in the RO bundle that may be used for PRACH repetition in accordance with the present subject matter.

When the ssb-perRACH-Occasion in combination with the parameter ssb-perRACH-OccasionAndCB-PreamblesPerSSB is 1/n (n=2, 4, 8), then n RACH occasions may be candidates for RACH transmission. In the conventional manner, only one possible candidate may be selected or indicated for RACH transmission. However, when PRACH repetition is configured or activated, many more candidates in the RACH bundle may be used for PRACH repetition transmission. For example, if the ssb-perRACH-Occasion in combination with the parameter ssb-perRACH-OccasionAndCB-PreamblesPerSSB is 1/8, the PRACH repetition numbers can be from 2 to a maximum of 8. If the ssb-perRACH-Occasion in combination with the parameter ssb-perRACH-OccasionAndCB-PreamblesPerSSB is 1/4, the PRACH repetition numbers can be from 2 to a maximum of 4. As used herein, a repetition number may be equivalently referred to as a repetition factor in accordance with the present subject matter.

There may be several combinations between the maximum possible candidates of PRACH occasions and the number of PRACH repetitions. For instance: (1) maximum possible candidates of PRACH occasions=8; number of PRACH repetition=2, 4, or 8; (2) maximum possible candidates of PRACH occasions=4; number of PRACH repetition=2 or 4; or (3) maximum possible candidates of PRACH occasions=4; number of PRACH repetition=2.

The PRACH mask index table for reserved indexes is provided in Table 2 below:

TABLE 2
Reserved Indexes used for PRACH repetition

| PRACH Mask | |
|---|---|
| Index | Allowed PRACH occasion(s) of SSB |
| 0 | All |
| 1 | PRACH occasion index 1 |
| 2 | PRACH occasion index 2 |
| 3 | PRACH occasion index 3 |
| 4 | PRACH occasion index 4 |
| 5 | PRACH occasion index 5 |
| 6 | PRACH occasion index 6 |
| 7 | PRACH occasion index 7 |
| 8 | PRACH occasion index 8 |
| 9 | Every even PRACH occasion |
| 10 | Every odd PRACH occasion |
| 11 | All PRACH occasions for PRACH repetition |
| 12 | First half of PRACH occasions for PRACH |
| | repetition |
| 13 | Second half of PRACH occasions for PRACH |
| | repetition |
| 14 | First quarter of PRACH occasions for PRACH |
| | repetition |
| 15 | Second quarter of PRACH occasions for |
| | PRACH repetition |

Indexes from 11 to 15 are the reserved indexes for PRACH repetition and may be used as in Table 2 for indicating PRACH repetition.

In index 11, all PRACH occasions in the RO bundle may be used for PRACH repetition, where the number of available PRACH occasions may be equivalent to the number of PRACH repetitions; e.g.: (1) maximum possible candidates of PRACH occasions=8; number of PRACH repetition=8; (2) maximum possible candidates of PRACH occasions=4; number of PRACH repetition=4; or (3) maximum possible candidates of PRACH occasions=2; number of PRACH repetition=2.

In index 12, a first half of PRACH occasions in the bundle may be used for PRACH repetition, where the number available PRACH occasions may be twice as many as the number of PRACH repetitions; e.g.: (1) maximum possible candidates of PRACH occasions=8; number of PRACH repetition=4; or (2) maximum possible candidates of PRACH occasions=4; and number of PRACH repetition=2.

In index 13, a second half of PRACH occasions in the bundle may be used for PRACH repetition, where the number of available PRACH occasions may be twice as many as the number of PRACH repetitions; e.g.: (1) maximum possible candidates of PRACH occasions=8; number of PRACH repetition=4; or (2) maximum possible candidates of PRACH occasions=4; number of PRACH repetition=2.

In index 14, a first quarter of PRACH occasions in the bundle may be used for PRACH repetition, where the number of available PRACH occasions may be four times as many as the number of PRACH repetitions; e.g., maximum possible candidates of PRACH occasions=8; number of PRACH repetition=2.

In index 15, a second quarter of PRACH occasions in the bundle may be used for PRACH repetition, where the number of available PRACH occasions may be four times as many as the number of PRACH repetitions; e.g., maximum possible candidates of PRACH occasions=8; number of PRACH repetition=2.

Obviously, the current reserved indexes are insufficient for all the possible RACH occasion allocation alternatives. The PRACH mask index table may be extended to include additional rows. The extended index rows may be provided in Table 3 below:

TABLE 3
Extended Indexes for PRACH repetition

| | |
|---|---|
| 16 | Third quarter PRACH occasions for PRACH |
| | repetition |
| 17 | Fourth quarter PRACH occasions for PRACH |
| | repetition |
| 18 | Every even PRACH occasions for PRACH |
| | repetition |
| 19 | Every odd PRACH occasions for PRACH |
| | repetition |
| 20 | The starting PRACH occasion X for PRACH |
| | repetition |
| 21 | The starting PRACH occasion X for PRACH |
| | repetition and repetition factor = Y |
| 22 | A pattern to define the RO allocation for |
| | different PRACH repetition factor |

Indexes 11-15 in Table 2 and indexes 16-19 in Table 3 may indicate the PRACH repetition factor and RO position. For instance, if the available RO position is 8, which is due to the ssb-perRACH-Occasion being 1/8, then index 16 indicates the repetition factor (1/4)*8=2, and the starting position of PRACH is the 5^{th} RO of the ROs 1 through 8.

Index 20 may indicate the starting PRACH occasion X, where X may be any integer between 1 and 8 (or any other value set) for PRACH repetition when the PRACH repetition factor is notified via signaling or otherwise implicitly understood by both the base station 200 and the UE 300.

Index 21 may indicate the starting PRACH occasion X and the repetition factor Y for PRACH repetition. Each combination of X and Y may occupy one row in the table. If X is any integer from 1 to 8, and Y is any integer within the set of [1, 2, 4, 8], there are 32 possible combinations of X and Y. Therefore, the PRACH mask index table may optimally include 64 rows, and the index may be a binary value with 6-bit width, as extended from the conventional 4-bit width.

Index 22 may describe a pattern to define the RO usage for a different repetition factor when PRACH mask index is a common parameter, such as an SI request-triggered PRACH. For example, the first RO may be for repetition factor=1, the second and third RO may be for repetition factor=2, the fourth, fifth, sixth, and seventh RO may be for repetition factor=4.

The newly added indexes may not be limited to the example shown above, and not all examples should be included in the table. Any combination of above examples in each row and possible reasonable extensions and variations may be investigated and specified.

The PRACH mask index in Table 1 may also be “reinterpreted” for PRACH repetition if PRACH repetition is simultaneously configured. The reinterpreted rows of the mask index table are provided in Table 4 below:

TABLE 4
Reinterpreted PRACH mask indexes

| PRACH Mask | |
|---|---|
| Index | Allowed PRACH occasion(s) of SSB |
| 0 | All |
| 1 | PRACH occasion index 1 |
| 2 | PRACH occasion index 2 |
| 3 | PRACH occasion index 3 |
| 4 | PRACH occasion index 4 |
| 5 | PRACH occasion index 5 |
| 6 | PRACH occasion index 6 |
| 7 | PRACH occasion index 7 |
| 8 | PRACH occasion index 8 |
| 9 | Every even PRACH occasion |
| 10 | Every odd PRACH occasion |

In index 0, “All” may be interpreted as all PRACH occasions are for PRACH repetition.

In PRACH Mask Indexes 1-8, the PRACH occasion indexes 1, 2, 3, 4, 5, 6, 7, 8 may be interpreted as the starting PRACH occasions for PRACH repetition. The UE 300 may have knowledge of the repetition factor but not from the table. In indexes 9 or 10, the even or odd PRACH occasions may also be interpreted as the PRACH occasions for PRACH repetition. The conventional index interpretation of Table 1 and the reserved/extended indexes in Tables 2 and 3 may also be combined for PRACH repetition.

Tables 2-4 may be based on the conventional PRACH mask index table to use the original, reserved, or extended indexes. The following introduces a new mask index table design. If a UE capability supports PRACH repetition and reports this capability to a base station 200, UE 300 may select whether to perform PRACH repetition, or the base station 200 may indicate to the UE 300 perform PRACH repetition; i.e., both the UE 300 and the base station 200 understand PRACH repetition is activated. The base station 200 may distinguish whether the UE 300 applies repetition from the PRACH preamble index or time/frequency resource used by the UE 300. It may also be possible to specify a new PRACH mask index table specifically for PRACH repetition, as most of cases previously discussed are under the UE-specific parameter indication.

The UEs 300 with PRACH repetition may share the newly designed PRACH mask index table. The newly designed PRACH mask index table may include one or more rows from example Tables 2 and 3. Alternatively, or in addition, the original Table 1 indexes 0-10 may also be replaced by new entries.

When the UEs 300 with PRACH repetition do not share the new PRACH mask index table, an individual table may be indicated to each UE 300 through UE-specific RRC parameter(s). The individual table design should consider the actual repetition factor and ssb-perRACH-Occasion.

Alternatively, or in addition, the RO indication in the RO bundle may be directly indicated to a UE 300 through UE-specific RRC parameter(s) without the aid of the PRACH mask index table.

Alternatively, or in addition, the direct RO indication may not be used if the PRACH resource configured by ssb-ResourceList matches the actual repetition factor of the UE 300. In this case, the UE 300 may directly use the PRACH resource configured by ssb-ResourceList without any further RO indication.

When the newly designed PRACH mask index table is available for a UE 300 with PRACH repetition, for RACH triggered by PDCCH order, the UE 300 may identify whether to use the new table for PRACH repetition. If the preamble index for PRACH repetition is within a specific set of preamble index without any collision to the PRACH without repetition, the UE 300 may read the preamble index first in PDCCH order and understand whether the PRACH is repeated. Then the UE 300 may read the PRACH mask index field after the preamble index field and identify whether the PRACH mask index is for PRACH repetition or not. It may also be helpful to identify the bit-width used by the PRACH mask index if an extension of PRACH mask index table is adopted (e.g., 4 bits->6 bits). If the UE 300 cannot identify whether the PRACH repetition is used through the preamble index field, an explicit indication in PDCCH order for activation of PRACH repetition may be specified. The explicit indication in PDCCH order may be achieved using any of the many unused reserved bits in PDCCH order.

The reserved bits in PDCCH order may also be used to indicate the time or frequency domain resource for PRACH repetition. An offset to the time or frequency domain resource of PRACH without repetition may be indicated to UE 300 in PDCCH order. More specifically, for a time domain resource, some offset parameters may be considered, such as a scaling factor to extend the periodicity of the baseline configuration indicated by prach-ConfigurationIndex, or a frame or subframe/slot.

PRACH transmission may be triggered by an SI request, such as the RRC parameter ra-ssb-OccasionMaskIndex, which indicates the PRACH occasions for the PRACH transmission is the common RRC parameter for a group of UEs 300. To differentiate the UE 300 having a different repetition factor, the rach-OccasionsSI may be separately configured based on the different repetition factor. Alternatively, or in addition, the UE 300 with different repetition factor may be differentiated by configuring the specific preamble index resource pools for the UE 300 with different PRACH repetition factors.

In sum, the PRACH mask index table may be reused based on the conventional table. In a first example, the reserved indexes in the PRACH mask index table may be used for PRACH repetition. In a second example, extended indexes from the PRACH mask index table are used for PRACH repetition. In a third example, the conventional PRACH mask index in the PRACH mask index table may be reinterpreted for PRACH repetition. Each row in Tables 2-4 may form the basis for an individual example of PRACH repetition.

Alternatively, or in addition, a new PRACH mask index table may be designed. In a first example, UEs 300 with PRACH repetition may share the new PRACH mask index table. In a second example, UEs 300 with PRACH repetition may not share the new PRACH mask index table, and an individual table may be provided to each UE 300 through a UE-specific RRC parameter.

Alternatively, or in addition, no PRACH mask index table may be used for PRACH repetition. Instead, in a first example, an RO indication may be directly indicated to the UE 300 through a UE-specific RRC parameter without the aid of a PRACH mask index table. In a second example, a PRACH resource configured by ssb-ResourceList may be used directly without any further RO indication.

For RACH triggered by PDCCH order, if the preamble index for PRACH repetition is within a specific set of preamble index without any collisions to the non-repetitive PRACH, the UE 300 may identify whether to use the PRACH mask index table for PRACH repetition by first reading the preamble index field.

If the UE 300 cannot identify whether the PRACH repetition is used through the preamble index field, an explicit indication in PDCCH order for activation of PRACH repetition may be specified to indicate whether the PRACH repetition is used.

The reserved bits in PDCCH order may also be used to indicate the time or frequency domain resource for PRACH repetition. An offset to the time or frequency domain resource of PRACH without repetition may be indicated to the UE 300 carried in PDCCH order. More specifically, for time domain resource, some offset parameters may be considered, such as, a scaling factor to extend the periodicity of the baseline configuration indicated by prach-ConfigurationIndex, frame offset, or subframe/slot offset.

### Resource Indication for PRACH Repetition by Ra-OccasionList

If the dedicated PRACH resource is configured by ra-OccasionList, and the associated downlink signal is the channel state information reference signal (CSI-RS), in the conventional technique, UE will randomly select any one of ROs in the PRACH resource configured by ra-OccasionList according to the association with the selected CSI-RS.

If there are multiple ROs in the PRACH resource configured by ra-OccasionList associated with one certain CSI-RS, the multiple ROs may be regarded as a PRACH RO bundle for PRACH repetition transmission. For example, if the UE 300 needs to repeat PRACH 8 times, the configuration of ra-OccasionList may assign 8 ROs for one RO bundle.

If the number of ROs assigned by ra-OccasionList is larger than the needed number of PRACH repetitions, the ROs in the RO bundle that will be allocated to UE for PRACH repetition may be identified. The identification may be made explicitly by additional RRC parameters, for example, an RRC parameter ra-CSIRS-OccasionMaskIndex, which may be copied from ra-ssb-OccasionMaskIndex. A same or similar PRACH mask index table may also be predefined or specified. Alternatively, a direct indication in the additional RRC parameter may also indicate which ROs will be allocated to UE for PRACH repetition. Implicit methods may also be used to identify the ROs to be used by UE implementation. For example, the UE 300 may always select the first n ROs in the RO bundle for PRACH repetition, or may determine the ROs by the unique UE ID, and the like.

In sum, a PRACH mask index table may be constructed or reused in the case where the dedicated PRACH resource is configured by ra-OccasionList, and the associated downlink signal is the CSI-RS. The ROs used by PRACH repetition may be indicated by RRC parameter ra-CSIRS-OccasionMaskIndex which may be copied from ra-ssb-OccasionMaskIndex.

Alternatively, a direct indication in a new Information Element (IE) may be added in the RRC parameter RACH-ConfigDedicated to indicate which ROs will be allocated to UE for PRACH repetition.

PRACH Repetition with Different Beams and Different Preamble Indexes.

Two kinds of conventional PRACH repetition solutions exist. One is the PRACH repetition with the same transmission beam, the other is the PRACH repetition with different beams. For PRACH repetition with different beams, different preamble indexes may be used for each PRACH repetition in the PRACH bundle. The benefit is the base station 200 will not try to coherently combine the reception of PRACH repetitions with different beams when the preamble indexes are different, as the combination of the reception of PRACH repetitions with different beams may bring the negative affect due to the incoherent channel. The other benefit may be to randomize the preamble indexes for PRACH repetition, which may reduce the collision probability with the same interference UE. The interference from one UE may be dispersed to multiple UEs, the gap of timing received at base station from interference UEs may be randomized and may improve the detection rate in base station.

The preamble indexes during the PRACH repetition bundle may be selected by a predefined pattern.

The predefined preamble index pattern may be regarded as a predefined grouped preamble indexes. The grouping rule may both understood by the base station 200 and UE 300. Some examples of the grouping rule include:
(1) The preamble indexes for PRACH repetition may be consecutive. The UE 300 may randomly select a preamble index for the first sample of PRACH repetitions, and the next preamble indexes may be the consecutive preamble indexes with ascending order or descending order. For instance, the preamble index group is [4, 5, 6, 7] for the PRACH repetition where the repetition factor is 4.
(2) The group of preamble index may be predefined. One predefined table specified in the specifications may specify this predefined group of preamble indexes.
(3) The preamble index in example (1) may not be the only solution for a predefined pattern. Some restrictions may also be added; for example, the starting index may be an even number or may be divided by the repetition factor, etc.

The preamble indexes during the PRACH repetition bundle may also be randomly selected by the base station 200, and the selected preamble indexes may be configured for the UE 300 through the RRC signaling or DCI signaling.

The preamble indexes during the PRACH repetition bundle may also be randomly scrambled by UE ID with no need to explicitly indicate the preamble indexes.

The UE ID may be a randomization sequence belonging to UE property. The UE ID may be used to scramble the binary bit of a fixed or predefined preamble index, and the scramble procedure may produce the new preamble index with the same bit-width with the original preamble index.

For example, when the PRACH repetition factor is 4, and UE 300 first selects the preamble index #3, then the whole original preamble index group is [3, 3, 3, 3] as decimal and [00000101, 00000101, 00000101, 00000101] as binary. The [000001010000010100000101] and UE ID are both input into the scrambler to generate the new sequence with a 32-bit width cut into four segments. Each segment is translated to decimal as the new preamble indexes for PRACH repetition. The 8-bit binary width for each preamble index assumes that the total number of preamble index bits is 64. The bit-width should be adjusted to the actual total number of preamble index bits.

If the zone of the preamble index for PRACH repetition is not the whole set of total preamble indexes, the preamble index input into scrambler may be the relative offset to the start preamble index. For example, the zone of preamble index for PRACH repetition is [32 to 63] in the whole set of [0 to 63], if the original preamble is 33, the relative offset to 32 is 1, and the binary bit input into the scrambler should be [0000001] with 7-bit width. The generated new sequence is also the relative offset to 32, and the actual preamble index should add 32 as well.

For the preamble indexes with predefined pattern or randomly scrambled by UE ID, the base station 200 may combine the reception of PRACH repetitions in a non-coherent way.

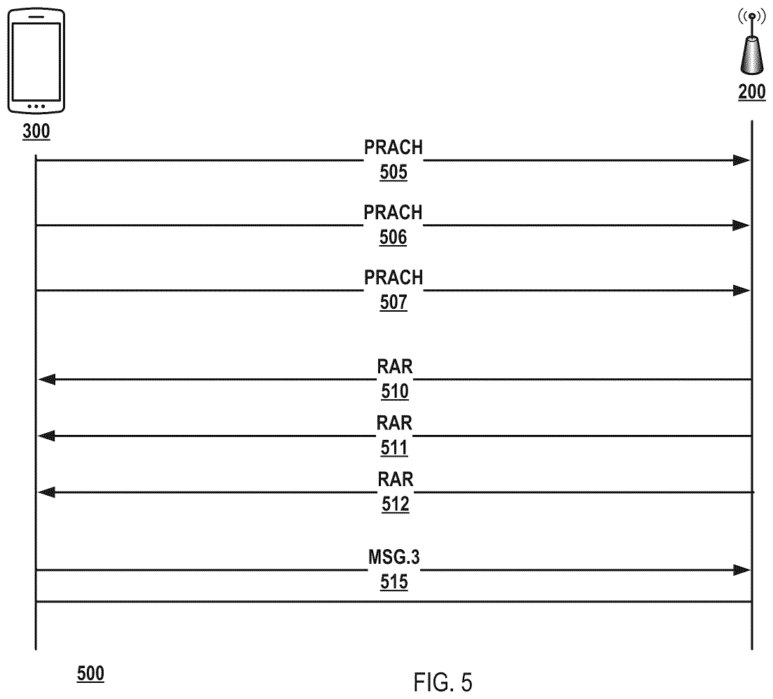

FIG. 5 illustrates a PRACH repetition communication 500 with different beams and different preamble indexes between the base station 200 and UE 300. When the UE 300 uses a different preamble index for each PRACH repetition 505-507 with different beams, the base station 200 may send multiple random access responses (RARs) 510-512 to respond to each PRACH repetition 505-507 as the conventional procedure. It is better to indicate a priority indication in each RAR 510-512 to the UE 300. The value of the “priority indicator” could be based on network side measurement on the received each PRACH repetition 505-507 and indicates the quality of the received PRACH repetitions 505-507. The UE 300 may receive multiple RARs 510-512 following one or more PRACH transmissions (within a RAR reception window). Then the UE 300 decodes and selects the RAR 510/511/512. RAR decoding means that the UE 300 may continue or terminate the RAR reception and decoding attempts after the successful reception of a RAR. RAR selection means that the UE 300 may select one or more RARs 510-512 based on the priority indication to respond to when it has received more than one RAR 510-512. When UE 300 selects one or more RARs 510-512, the UE 300 may continue to transmit one or more msg3(s) 515 to the base station 200 based on the selected RAR.

PRACH repetition with different beams may be regarded as individual PRACH from base station 200 aspect. The calculation of the random access radio network temporary identifier (RA-RNTI) is the same as the conventional technique.

If the collision between PRACH repetitions with different beams and PRACH repetitions with same beam cannot be avoided, to differentiate the two kinds of PRACH repetition, the base station 200 may change the calculation of RA-RNTI for the PRACH repetition with same beam. For example, the base station 200 may add an indication or parameter in the calculation of RA-RNTI for the PRACH repetition having the same beam.

The present subject matter describes methods, apparatus, and computer-readable medium for wireless communication. The present subject matter addressed the issues with scheduling multiple transmissions with one or more cells by reducing the number of bits needed to indicate scheduled transmissions. The methods, devices, and computer-readable medium described in the present subject matter may facilitate the performance of wireless transmission between a user equipment and a base station 200, thus improving efficiency and overall performance. The methods, devices, and computer-readable medium described in the present subject matter may improves the overall efficiency of the wireless communication systems.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for configuring physical random access channel (PRACH) retransmissions in a wireless communication network by a user equipment (UE), comprising: receiving a PRACH trigger comprising a random access channel occasion (RO) indication; transmitting a PRACH preamble to a base station during a first RO specified by the RO indication; transmitting one or more PRACH preamble repetitions to the base station during a second RO specified by the RO indication; and receiving a random access response (RAR) from the base station in response to the PRACH preamble and/or the one or more PRACH preamble repetitions.

A second aspect includes a method for configuring PRACH retransmissions in a wireless communication network by a base station, comprising: transmitting a PRACH trigger comprising an RO indication to a UE, wherein the PRACH trigger is one of: System Information (SI), a physical downlink control channel (PDCCH) order, ra-ssb-OccasionMaskIndex, or BeamFailureRecovery; receiving a PRACH preamble from the UE during a first RO specified by the RO indication; receiving one or more PRACH preamble repetitions from the UE during a second RO specified by the RO indication; and transmitting a RAR to the UE in response to the PRACH preamble and/or the one or more PRACH preamble repetitions.

A third aspect includes the method of the first or second aspects, wherein the RO indication is in a PRACH mask index table comprising 16 rows; and one or more of rows 12 to 16 are utilized to indicate the first RO and the second RO.

A fourth aspect includes the method of any preceding aspect, wherein the RO indication is in a PRACH mask index table comprising one or more reserved rows; and the one or more reserved rows are utilized to indicate the first RO and the second RO.

A fifth aspect includes the method of any preceding aspect, wherein the RO indication is in a PRACH mask index table that indicates: all PRACH occasions can be used for the one or more PRACH preamble repetitions; a first half of PRACH occasions can be used for the one or more PRACH preamble repetitions; a second half of PRACH occasions can be used for the one or more PRACH preamble repetitions; a first quarter of PRACH occasions can be used for the one or more PRACH preamble repetitions; a second quarter of PRACH occasions can be used for the one or more PRACH preamble repetitions; a third quarter of PRACH occasions can be used for the one or more PRACH preamble repetitions; a fourth quarter of PRACH occasions can be used for the one or more PRACH preamble repetitions; every even PRACH occasion can be used for the one or more PRACH preamble repetitions; or every odd PRACH occasion can be used for the one or more PRACH preamble repetitions.

A sixth aspect includes the method of any preceding aspect, wherein the RO indication is in a PRACH mask index table that indicates a starting PRACH occasion X can be used for the one or more PRACH preamble repetitions, where X is selected from a set consisting of 8 integers.

A seventh aspect includes the method of any preceding aspect, wherein the RO indication is in a PRACH mask index table that indicates a starting PRACH occasion X and a repetition factor Y can be used for the one or more PRACH preamble repetitions, where X is selected from a set consisting of 8 integers and Y is selected from a set consisting of 4 integers.

An eighth aspect includes the method of any preceding aspect, wherein the set consisting of 4 integers includes 1, 2, 4, and 8.

A ninth aspect includes the method of any preceding aspect, wherein the RO indication is in a PRACH mask index table comprising 64 rows, wherein each row is indexed by a 6-bit PRACH mask index.

A tenth aspect includes the method of any preceding aspect, wherein the RO indication is in a PRACH mask index table shared by all UEs within a cell.

An eleventh aspect includes the method of any preceding aspect, wherein the RO indication is in a PRACH mask index table individually assigned to the UE and not shared with any other UE in a cell.

A twelfth aspect includes the method of any preceding aspect, wherein the RO indication is in a PRACH mask index table conveyed within a UE-specific radio resource control (RRC) parameter.

A thirteenth aspect includes the method of any preceding aspect, wherein the PRACH trigger is a PDCCH order; and the RO indication is in a PRACH mask index table; and the method further comprises: identifying whether to use the PRACH mask index table by reading a preamble index field in the PDCCH order.

A fourteenth aspect includes the method of any preceding aspect, wherein the RO indication is in a PRACH mask index of the PRACH mask index table.

A fifteenth aspect includes the method of any preceding aspect, further comprising:
reading a PRACH mask index field after the preamble index field to identify whether the PRACH mask index is for PRACH repetition.

A sixteenth aspect includes the method of any preceding aspect, wherein the step of reading the PRACH mask index field after the preamble index field further comprises: identifying a bit-width of the PRACH mask index field.

A seventeenth aspect includes the method of any preceding aspect, wherein the PRACH trigger is a PDCCH order; and the RO indication is a PRACH mask index table; and the method further comprises: identifying whether to use the RO indication in the PRACH mask index table by reading an explicit indication in the PDCCH order.

An eighteenth aspect includes the method of any preceding aspect, wherein the PRACH trigger is a PDCCH order; and a plurality of reserved bits in the PDCCH order indicate a time or frequency domain resource for PRACH repetition.

A nineteenth aspect includes the method of any preceding aspect, wherein the PRACH trigger is a PDCCH order; and the PDCCH order includes an offset to a time or frequency domain resource of PRACH without repetition.

A twentieth aspect includes the method of any preceding aspect, wherein the RO indication is in ra-OccasionList; and the PRACH trigger is a channel state information reference signal (CSI-RS).

A twenty-first aspect includes the method of any preceding aspect, wherein the RO indication is in ra-CSIRS-OccasionMaskIndex; and the PRACH trigger is a channel state information reference signal (CSI-RS).

A twenty-second aspect includes a device for wireless communication comprising: a processor; and a memory in communication with the processor, the memory storing a plurality of instructions executable by the processor to cause the device to: implement the method of any preceding aspect.

A twenty-third aspect includes a non-transitory computer-readable medium comprising instructions operable, when executed by one or more processors, to: implement the method of aspects 1-22.

1. A method for configuring physical random access channel (PRACH) retransmissions in a wireless communication network by a user equipment (UE), comprising:
receiving a PRACH trigger comprising a random access channel occasion (RO) indication;
transmitting a PRACH preamble to a base station during a first RO specified by the RO indication;
transmitting one or more PRACH preamble repetitions to the base station during a second RO specified by the RO indication; and
receiving a random access response (RAR) from the base station in response to the PRACH preamble and/or the one or more PRACH preamble repetitions.

2. A method for configuring PRACH retransmissions in a wireless communication network by a base station, comprising:
transmitting a PRACH trigger comprising an RO indication to a UE, wherein
the PRACH trigger is one of:
System Information (SI),
a physical downlink control channel (PDCCH) order,
ra-ssb-OccasionMaskIndex, or
BeamFailureRecovery;
receiving a PRACH preamble from the UE during a first RO specified by the RO indication;
receiving one or more PRACH preamble repetitions from the UE during a second RO specified by the RO indication; and
transmitting a RAR to the UE in response to the PRACH preamble and/or the one or more PRACH preamble repetitions.

3. The method according to claim 1, wherein
the RO indication is in a PRACH mask index table comprising 16 rows; and
one or more of rows 12 to 16 are utilized to indicate the first RO and the second RO.

4. The method according to claim 1, wherein
the RO indication is in a PRACH mask index table comprising one or more reserved rows; and
the one or more reserved rows are utilized to indicate the first RO and the second RO.

5. The method according to claim 1, wherein
the RO indication is in a PRACH mask index table that indicates:
all PRACH occasions can be used for the one or more PRACH preamble repetitions;
a first half of PRACH occasions can be used for the one or more PRACH preamble repetitions;
a second half of PRACH occasions can be used for the one or more PRACH preamble repetitions;
a first quarter of PRACH occasions can be used for the one or more PRACH preamble repetitions;
a second quarter of PRACH occasions can be used for the one or more PRACH preamble repetitions;
a third quarter of PRACH occasions can be used for the one or more PRACH preamble repetitions;
a fourth quarter of PRACH occasions can be used for the one or more PRACH preamble repetitions;
every even PRACH occasion can be used for the one or more PRACH preamble repetitions; or
every odd PRACH occasion can be used for the one or more PRACH preamble repetitions.

6. The method according to claim 1, wherein
the RO indication is in a PRACH mask index table that indicates a starting PRACH occasion X can be used for the one or more PRACH preamble repetitions, where X is selected from a set consisting of 8 integers.

7. The method according to claim 1, wherein
the RO indication is in a PRACH mask index table that indicates a starting PRACH occasion X and a repetition factor Y can be used for the one or more PRACH preamble repetitions, where X is selected from a set consisting of 8 integers and Y is selected from a set consisting of 4 integers.

8. The method according to claim 7, wherein
the set consisting of 4 integers includes 1, 2, 4, and 8.

9. The method according to claim 1, wherein
the RO indication is in a PRACH mask index table comprising 64 rows, wherein
each row is indexed by a 6-bit PRACH mask index.

10. The method according to claim 2, wherein
the RO indication is in a PRACH mask index table shared by all UEs within a cell.

11. The method according claim 2, wherein
the RO indication is in a PRACH mask index table individually assigned to the UE and not shared with any other UE in a cell.

12. The method according to claim 1, wherein
the RO indication is in a PRACH mask index table conveyed within a UE-specific radio resource control (RRC) parameter.

13. The method according to claim 1, wherein
the PRACH trigger is a PDCCH order; and
the RO indication is in a PRACH mask index table; and the method further comprises:
identifying whether to use the PRACH mask index table by reading a preamble index field in the PDCCH order.

14. The method according to claim 13, wherein
the RO indication is in a PRACH mask index of the PRACH mask index table.

15. The method according to claim 13, further comprising:
reading a PRACH mask index field after the preamble index field to identify whether the PRACH mask index is for PRACH repetition.

16. The method according to claim 15, wherein the step of reading the PRACH mask index field after the preamble index field further comprises:
identifying a bit-width of the PRACH mask index field.

17. The method according to claim 1, wherein
the PRACH trigger is a PDCCH order; and
the RO indication is a PRACH mask index table; and the method further comprises:
identifying whether to use the RO indication in the PRACH mask index table by reading an explicit indication in the PDCCH order.

18. The method according to claim 1, wherein
the PRACH trigger is a PDCCH order; and
a plurality of reserved bits in the PDCCH order indicate a time or frequency domain resource for PRACH repetition.

19. The method according to claim 1, wherein
the PRACH trigger is a PDCCH order; and
the PDCCH order includes an offset to a time or frequency domain resource of PRACH without repetition.

20. The method according to claim 1, wherein
the RO indication is in ra-OccasionList; and
the PRACH trigger is a channel state information reference signal (CSI-RS).
